(19) United States
(12) Patent Application Publication
(10) Pub. No.: US 2026/0257767 A1
(43) Pub. Date: Sep. 3, 2026

(54) MARINE ENGINE AMMONIA CATCH SYSTEM AND AMMONIA FUEL RECOVERY METHOD USING SAME

(71) Applicant: KOREA INSTITUTE OF ENERGY RESEARCH, Daejeon (KR)

(72) Inventors: Hyung-chul YOON, Daejeon (KR); Hyung Kuk JU, Jeonju-si, Jeollabuk-do (KR); Hee-tae BEUM, Daejeon (KR); Sang-sup HAN, Daejeon (KR); Kanghee CHO, Daejeon (KR); Sun Hyung KIM, Daejeon (KR); Jae Hyung KIM, Daejeon (KR); Kyungho LEE, Daejeon (KR)

(73) Assignee: KOREA INSTITUTE OF ENERGY RESEARCH, Daejeon (KR)

(21) Appl. No.: 18/995,679

(22) PCT Filed: Nov. 28, 2023
(86) PCT No.: PCT/KR2023/019350

§ 371 Date: Jan. 16, 2025

(30) Foreign Application Priority Data
Dec. 28, 2022 (KR) 10-2022-0187479
Nov. 27, 2023 (KR) 10-2023-0167132

(51) Int. Cl. B63B 17/00; B63H 21/38

(52) U.S. Cl. CPC B63B 17/0027; B63H 21/38

(57) ABSTRACT

The present disclosure relates to a marine engine ammonia catch system and an ammonia fuel recovery method using the same. More particularly, according to the present disclosure, because a marine engine ammonia catch system includes a temperature swing adsorption device in which an adsorption tower is filled with a porous adsorbent, ammonia may be selectively removed from a mixed gas down to a ppm level and then recovered at a high concentration of 95% or more even when a small amount of porous adsorbent is used. Also, in the marine engine ammonia catch system according to the present disclosure, the release of ammonia into the atmosphere may be minimized, high-purity ammonia may be recovered by using ammonia as a purge gas at a low temperature of 200° C. or lower, and liquid ammonia formed by re-liquefying a highly concentrated ammonia gas generated during desorption may be reused in a fuel tank. In addition, because the marine engine ammonia catch system does not affect vessel movement, a more compact device configuration compared to an existing scrubber may be achieved, and the problem of ammonia water treatment may be solved.

### TECHNICAL FIELD

The present disclosure relates to a marine engine ammonia catch system and an ammonia fuel recovery method using the same, and more particularly, to a marine engine ammonia catch system and an ammonia fuel recovery method using the same, which may have a high performance of adsorbing ammonia from among nitrogen (N₂), ammonia (NH₃), and water (H₂O) in a mixed gas including an ammonia gas without atmospheric emissions of ammonia through a temperature swing adsorption device for ammonia catch to prevent atmospheric emissions of ammonia from an ammonia fueled vessel and may recover high-purity ammonia as fuel through cleaning and desorption of a high-purity ammonia gas.

### BACKGROUND ART

Ammonia fueled vessel engines require an ammonia fuel tank, a fuel supply line, a nitrogen supply facility for purging unused ammonia remaining in a pipe, and a zero-emission ammonia catch system for reducing atmospheric emissions, to supply required ammonia fuel.

Zero-emission for ammonia fueled vessels pursues a system that may recover ammonia into fuel without the release of ammonia into the atmosphere.

Ammonia fueled vessels purge and remove ammonia in pipes in order to prevent corrosion of ammonia engine components during abnormal operation or stoppage. However, because it is illegal to release the purged ammonia into the atmosphere or dissolve the purged ammonia in seawater, engine manufacturers use scrubber systems using water or an acidic absorbing solution as ammonia catch systems.

These scrubber systems are useful in that they are devices used to remove ammonia in pipes, but have problems in that a lot of water or absorbing solution is required to remove ammonia to a low concentration and dissolved ammonia is re-released when the water or the absorbing solution is saturated with ammonia. In addition, the scrubber systems have problems in that they have larger volumes and heights than land-based systems and it is difficult to apply the scrubber systems in limited spaces of vessels. That is, ammonia water may only be processed on land and it is difficult to recover ammonia from ammonia water.

Accordingly, research and development are needed for new zero-emission ammonia catch systems that may solve many problems of scrubber systems applied to ammonia fueled vessels and may capture and recover unused ammonia remaining in ammonia supply pipelines of ammonia fueled vessels without the release of ammonia into the atmosphere.

### RELATED LITERATURES

### Patent Literatures

1. Korean Patent No. 10-2312060
2. Korean Patent Publication No. 10-2014-0079485
3. Korean Patent Publication No. 10-2019-0042280
4. Korean Patent No. 10-2111525

### DISCLOSURE

### Technical Problem

To solve the problems, the present disclosure provides a marine engine ammonia catch system in which the efficiency of adsorbing and removing ammonia is significantly improved by including a temperature swing adsorption device and high-purity ammonia recovery is possible by using ammonia as a purge gas.

Also, the present disclosure provides an ammonia fuel recovery method using a marine engine ammonia catch system.

### Technical Solution

An aspect of the present disclosure relates to a marine engine ammonia catch system including a temperature swing adsorption device, wherein the temperature swing adsorption device includes: a plurality of adsorption towers connected to a raw material supply pipe and including an ammonia removal unit configured to adsorb and remove ammonia from a mixed gas introduced from the raw material supply pipe, a nitrogen storage tank connected to the plurality of adsorption towers and storing nitrogen separated after the ammonia is removed from the mixed gas in the plurality of adsorption towers, a gas-liquid separation bath configured to separate purified ammonia from the plurality of adsorption towers, a compressor connected to the gas-liquid separation bath and configured to liquefy the ammonia, an ammonia storage tank storing the liquefied ammonia, a plurality of pipes connecting the plurality of adsorption towers, the nitrogen storage tank, the gas-liquid separation bath, the compressor, and the ammonia storage tank, and a plurality of valves configured to respectively open and close the plurality of pipes.

In an embodiment, each of the plurality of adsorption towers may be filled with a porous adsorbent that selectively adsorbs ammonia in the mixed gas supplied through the raw material supply pipe, wherein the porous adsorbent includes 80 to 100 wt % of zerolite and 0 to 20 wt % of at least one selected from among a metal-impregnated activated carbon adsorbent, a silica adsorbent, an alumina adsorbent, and an alumina-silica adsorbent.

In another embodiment, the plurality of valves configured to respectively open and close the plurality of pipes may include a nitrogen gas injection valve connected to the plurality of adsorption towers and the nitrogen storage tank and configured to inject a nitrogen gas, a nitrogen gas recovery valve connected to the plurality of adsorption towers and the nitrogen storage tank and configured to recover a nitrogen gas, an ammonia purge gas injection valve connected to the plurality of adsorption towers and the gas-liquid separation bath and configured to inject an ammonia purge gas, and an ammonia recovery valve connected to the plurality of adsorption towers and the compressor and configured to recover ammonia.

In another embodiment, the marine engine ammonia catch system may further include a nitrogen recovery pipe configured to recover part of nitrogen stored in the nitrogen storage tank from the nitrogen storage tank to the plurality of adsorption towers, wherein the plurality of valves configured to respectively open and close the plurality of pipes additionally include a nitrogen gas injection valve connected to the nitrogen storage tank and the plurality of adsorption towers and configured to inject a nitrogen gas.

In another embodiment, the marine engine ammonia catch system may further include an ammonia recovery pipe configured to recover part of ammonia stored in the ammonia storage tank from the ammonia storage tank to the plurality of adsorption towers, wherein the plurality of valves configured to respectively open and close the plurality of pipes additionally include an ammonia gas injection valve connected to the ammonia storage tank and the plurality of adsorption towers and configured to inject ammonia.

Also, another aspect of the present disclosure relates to an ammonia fuel recovery method using the marine engine ammonia catch system including the temperature swing adsorption device according to various embodiments of the present disclosure, the ammonia fuel recovery method including a step of selectively adsorbing ammonia by passing a mixed gas supplied from the raw material supply pipe through the plurality of adsorption towers, a step of storing nitrogen remaining after the ammonia is adsorbed in the nitrogen storage tank, a step of heating an adsorption tower including a porous adsorbent to which the ammonia is adsorbed to desorb the ammonia from the porous adsorbent to which the ammonia is adsorbed, a step of compressing and liquefying the desorbed ammonia with a compressor, a step of separating liquid ammonia and residual nitrogen from the liquefied ammonia, and a step of recovering the liquid ammonia and storing the recovered liquid ammonia in the ammonia storage tank.

In an embodiment, the step of desorbing the ammonia may further include a nitrogen gas purge step of supplying part of nitrogen stored in the nitrogen storage tank to the plurality of adsorption towers as a purge gas.

In another embodiment, the nitrogen gas purge step may be performed for 1/1000 to 1/100 of a total desorption step time at an end of the desorption step.

In another embodiment, the step of desorbing the ammonia may further include an ammonia purge step of supplying part of ammonia stored in the ammonia storage tank to the plurality of adsorption towers as a purge gas.

In another embodiment, ammonia supplied in the ammonia purge step may have a concentration of 99% or more.

In another embodiment, the step of desorbing the ammonia from the porous adsorbent to which the ammonia is adsorbed may be performed at atmospheric pressure at a temperature of 100 to 220° C.

In another embodiment, each of the plurality of adsorption towers may be filled with a porous adsorbent that selectively adsorbs ammonia in the mixed gas supplied through the raw material supply pipe, wherein the porous adsorbent includes 80 to 100 wt % of zerolite and 0 to 20 wt % of at least one selected from among a metal-impregnated activated carbon adsorbent, a silica adsorbent, an alumina adsorbent, and an alumina-silica adsorbent.

In another embodiment, the step of adsorbing the ammonia may be performed so that a content of ammonia in the mixed gas at room temperature and atmospheric pressure is less than 1 ppm, wherein a time for which the adsorbing of the ammonia is maintained exceeds 40 minutes, and a concentration of the recovered ammonia is 99 vol % or more.

### Advantageous Effects

A marine engine ammonia catch system according to the present disclosure includes various elements including a temperature swing adsorption device and a porous adsorbent filled in an adsorption tower, and the marine engine ammonia catch system may selectively recover only ammonia at a high concentration from a mixed gas even using a small amount of porous adsorbent.

Also, because the marine engine ammonia catch system according to the present disclosure may reduce the residual amount of ammonia in recovered nitrogen and increase an ammonia recovery concentration, pollution caused by ammonia emissions may be minimized, and liquid ammonia formed by re-liquefying a highly concentrated ammonia gas generated during desorption may be stored in a fuel tank for reuse.

In addition, because the marine engine ammonia catch system does not affect vessel movement, a more compact device configuration compared to an existing scrubber may be achieved, and the problem of ammonia water treatment may be solved. Because an adsorption time is increased by using nitrogen as an ammonia purge gas, the use of a small amount of adsorbent and the compact design of the adsorption tower are possible, and thus, installation costs may be reduced.

The effects of the present disclosure are not limited to the effects mentioned above. It should be understood that the effects of the present disclosure include all effects that may be inferred from the following description.

### DESCRIPTION OF DRAWINGS

FIG. 1 is a diagram illustrating a configuration of a marine engine ammonia catch system according to the present disclosure.

### BEST MODE

Hereinafter, the present disclosure will be described in more detail with one embodiment.

The present disclosure relates to a marine engine ammonia catch system and an ammonia purification method using the same.

As described above, existing ammonia fueled vessels use scrubber systems using water or an acidic absorbing solution as ammonia catch systems. However, the scrubber systems have problems in that a lot of water or absorbing solution is required to remove ammonia to a low concentration and dissolved ammonia is re-released when the water or the absorbing solution is saturated with ammonia. In addition, the scrubber systems have problems in that they have larger volumes and heights than land-based systems and it is difficult to apply the scrubber systems to limited spaces of vessels.

Accordingly, the present disclosure provides a marine engine ammonia catch system of a temperature swing adsorption (TSA) device. Because the marine engine ammonia catch system is manufactured by filling an adsorption tower with a porous adsorbent, only ammonia may be selectively removed from a mixed gas down to a ppm level and then ammonia may be recovered at a high concentration of 95% or more even by using a small amount of porous adsorbent.

Accordingly, the release of ammonia into the atmosphere may be minimized, high-purity ammonia may be recovered by using ammonia as a purge gas at a low temperature of less than 200° C., and liquid ammonia formed by re-liquefying a highly concentrated ammonia gas generated during desorption may be reused in a fuel tank. In addition, because the marine engine ammonia catch system does not affect vessel movement, a compact device configuration compared to an existing scrubber may be achieved, and the problem of ammonia water treatment may be solved.

In detail, the present disclosure provides a marine engine ammonia catch system including a TSA device 100. The TSA device 100 includes:
a plurality of adsorption towers 111, 112, 113 connected to a raw material supply pipe 101 and including an ammonia removal unit;
a nitrogen storage tank 131 connected to the adsorption towers and storing nitrogen separated from a mixed gas in the adsorption towers;
a gas-liquid separation bath 141 configured to separate purified ammonia from the adsorption towers;
a compressor 107 connected to the gas-liquid separation bath 141 and configured to liquefy the ammonia;
an ammonia storage tank 121 storing the liquefied ammonia; and
valves configured to open and close a plurality of pipes connecting the adsorption towers, the nitrogen storage tank 131, the gas-liquid separation bath 141, the compressor 107, and the ammonia storage tank 121.

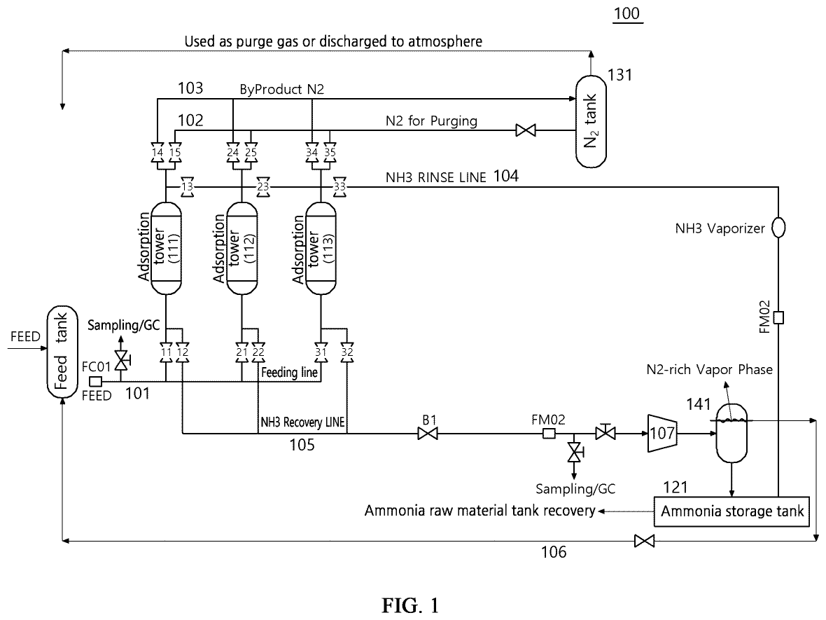

FIG. 1 is a diagram illustrating a configuration of a marine engine ammonia catch system according to the present disclosure. Referring to FIG. 1, the adsorption tower includes a plurality of adsorption towers connected to the raw material supply pipe 101 and including an ammonia removal unit, and the marine engine ammonia catch system includes the nitrogen storage tank 131 connected to the adsorption tower and storing nitrogen separated from a mixed gas in the adsorption tower. Also, the marine engine ammonia catch system includes the gas-liquid separation bath 141 configured to separate purified ammonia from the adsorption tower, the compressor 107 connected to the gas-liquid separation bath 141 and configured to liquefy the ammonia, and the ammonia storage tank 121 in which the liquefied ammonia is stored. Also, the marine engine ammonia catch system includes valves configured to open and close a plurality of pipes 102-105 connecting the adsorption tower, the nitrogen storage tank 131, the gas-liquid separation bath 141, the compressor 107, and the ammonia storage tank 121.

The TSA device 100 may continuously and repeatedly perform steps such as adsorption, heating regeneration, cooling, and waiting, and may selectively adsorb only ammonia to a porous adsorbent from a mixed gas of ammonia (NH₃) and nitrogen (N₂) at room temperature or low temperature under constant pressure, and may desorb the ammonia by heating the adsorption tower to increase a temperature.

The adsorption tower may include two or more adsorption towers arranged at certain intervals in parallel, and preferably may include three adsorption towers.

First, second, and third adsorption towers exemplarily illustrated in FIG. 1 may operate as follows. A mixed gas including nitrogen and ammonia of a vessel fuel pipe may be introduced through a raw material injection valve 11 provided in the raw material supply pipe 101 and the first adsorption tower 111 may perform a removal process through ammonia adsorption. The mixed gas may be at atmospheric pressure to 3 bar and may be preferably maintained at atmospheric pressure.

The second adsorption tower 112 and the third adsorption tower 113 may perform heating regeneration, cooling, and waiting processes. The regeneration process may be performed using a heating furnace or an electric heater, and may be performed at a temperature of 200° C. or lower.

A nitrogen gas separated from the mixed gas is stored in a nitrogen tank through a nitrogen gas recovery valve 14.

The first adsorption tower 111 that has completed the adsorption process may block the nitrogen gas recovery valve 14 to heat to a desorption temperature through a heater and may open and close an ammonia recovery valve 12 to recover ammonia used as a purge gas and adsorbed ammonia.

In this case, part of the nitrogen stored in the nitrogen tank may be selectively supplied as a purge gas to the adsorption tower, and an ammonia purge gas may be selectively supplied through an ammonia purge gas injection valve 13 while heating.

A gas-liquid mixture such as liquefied ammonia and nitrogen as a purge gas may be transferred to the gas-liquid separation bath 141 through the compressor 107. The liquefied ammonia may exist in a lower portion of the gas-liquid separation bath 141, and the liquefied ammonia may be recovered and reused as ammonia fuel in the ammonia storage tank 121. A nitrogen gas and an ammonia gas may exist in an upper portion of the gas-liquid separation bath 141, and the mixed gas of nitrogen and ammonia may be recovered back to the raw material supply pipe 101 to prevent ammonia emissions into the air.

While the first adsorption tower 111 performs regeneration, the second adsorption tower 112 may perform an adsorption process by opening a raw material injection valve 21 and a nitrogen purge gas recovery valve 24, and the third adsorption tower 113 may wait for cooling and adsorption processes. After the heating regeneration of the first adsorption tower 111 is completed, all valves may be blocked, and the third adsorption tower 113 may cool ammonia to room temperature by using seawater. The second adsorption tower 112 and the second adsorption tower 113 may sequentially perform processes in the same manner as the first adsorption tower 111 by opening and closing valves in the order of ammonia adsorption, heating regeneration, desorption, cooling, and waiting.

The adsorption tower may include a heating furnace or an electric heater for heating at 200° C., and a temperature of the adsorption tower should be lowered after high-temperature desorption, and in this case, preferably, the adsorption tower may be cooled by using seawater.

The adsorption tower may be filled with a porous adsorbent that selectively adsorbs ammonia from a mixed gas supplied through the raw material supply pipe 101.

The porous adsorbent may include at least one selected from the group consisting of zeolite, a metal-impregnated activated carbon adsorbent, a silica adsorbent, an alumina adsorbent, and an alumina-silica adsorbent as an adsorbent for adsorbing an ammonia component. Preferably, the porous adsorbent may be zeolite.

The adsorption tower may be filled with 80 to 100 wt %, preferably 92 to 100 wt %, more preferably 93 to 100 wt %, and most preferably 95 to 100 wt % of porous adsorbent.

The nitrogen storage tank 131 may pressurize and reuse high-purity nitrogen or may discharge nitrogen into the atmosphere.

The gas-liquid separation bath 141 may discharge nitrogen to the air through an upper portion. In this case, the marine engine ammonia catch system may further include a nitrogen-ammonia recovery pipe 106 configured to recover a gas including a small amount of nitrogen and ammonia to the raw material supply pipe 101 when nitrogen is discharged into the air from the gas-liquid separation bath 141.

Valves for opening and closing the plurality of pipes 102-105 may include: raw material injection valves 11, 21, 31 connected to the raw material supply pipe 101 and the adsorption tower and configured to inject a raw material; nitrogen gas injection valves 15, 25, 35 connected to the adsorption tower and the nitrogen storage tank 131 and configured to inject a nitrogen gas; nitrogen gas recovery valves 14, 24, 34 connected to the adsorption tower and the nitrogen storage tank 131 and configured to recover a nitrogen gas; ammonia purge gas injection valves 13, 23, 33 connected to the adsorption tower and the gas-liquid separation bath 141 and configured to inject an ammonia purge gas; and ammonia recovery valves 12, 22, 32 connected to the adsorption tower and the compressor 107 and configured to recover ammonia.

Also, the present disclosure provides an ammonia fuel recovery method using the marine engine ammonia catch system according to the present disclosure including the TSA device 100. The ammonia fuel recovery method includes: a step of selectively adsorbing ammonia by passing a mixed gas supplied from the raw material supply pipe through the adsorption tower; a step of storing nitrogen remaining after the ammonia is adsorbed in the nitrogen storage tank; a step of heating an adsorption tower including a porous adsorbent to which the ammonia is adsorbed to desorb the ammonia from the porous adsorbent to which the ammonia is adsorbed; a step of compressing and liquefying the desorbed ammonia through a compressor; a step of separating liquid ammonia and residual nitrogen from the liquefied ammonia; and a step of recovering the liquid ammonia and storing the recovered liquid ammonia in the ammonia storage tank.

The step of selectively adsorbing the ammonia may be performed so that the content of ammonia in the mixed gas at room temperature and atmospheric pressure is less than 1 ppm, preferably less than 0.7 ppm, more preferably less than 0.3 ppm, and most preferably less than 0.1 ppm.

In the step of supplying ammonia as a purge gas from the ammonia storage tank 121, a concentration of an ammonia purge gas may be 99% or more.

The step of desorbing the ammonia from the porous adsorbent to which the ammonia is adsorbed may be performed at atmospheric pressure at a temperature of 100 to 220° C., preferably 150 to 210° C., and most preferably 190 to 200° C. under an ammonia purge environment.

The step of desorbing the ammonia from the porous adsorbent to which the ammonia is adsorbed may be performed so that a desorption concentration of the ammonia desorbed from the porous adsorbent is 91 vol % or more, preferably 93 vol % or more, and most preferably 95 vol % or more. When a desorption concentration of the ammonia recovered from the porous adsorbent is less than 91 vol %, it may be sent to an incineration system (flare stack) for incineration.

In particular, although not explicitly described in the following embodiments or comparative example, an ammonia recovery cycle was performed 200 times or more by varying some or all of the following conditions to adsorb and recover ammonia from a mixed gas by using the marine engine ammonia catch system according to the present disclosure, and the re-usability and long-term stability of the ammonia catch system were measured by using a conventional method.

As a result, it was found that, when all conditions of \textcircled{1} ammonia fuel recovery using the marine engine ammonia catch system according to the present disclosure, \textcircled{2} desorption conditions of atmospheric pressure and 180 to 220° C., and \textcircled{3} nitrogen purge gas introduction in a desorption step were satisfied, the residual amount of ammonia in a nitrogen gas after adsorption was greatly reduced, an adsorption time was greatly increased, and an a recovered ammonia concentration was greatly increased. It was found that when any one of the conditions was not satisfied, some of the effects among the residual amount of ammonia in the nitrogen gas after adsorption, the adsorption time, and the recovered ammonia concentration may be improved but not all of the effects were improved.

In addition to the conditions of \textcircled{1} ammonia fuel recovery using the marine engine ammonia catch system according to the present disclosure, \textcircled{2} desorption conditions of atmospheric pressure and 180 to 220° C., and \textcircled{3} nitrogen purge gas introduction in the desorption step, when a condition of \textcircled{4} introduction of an ammonia gas with a concentration of 99% or more in the desorption step was satisfied, it was found that the residual amount of ammonia in the nitrogen gas after adsorption, the adsorption time, and the recovered ammonia concentration were improved more than when only the conditions \textcircled{1} to \textcircled{3} were satisfied, and the effects may not be reduced at all in terms of the residual amount of ammonia in the nitrogen gas after adsorption, the adsorption time, and the recovered ammonia concentration even after performing the cycle 200 times or more.

Hereinafter, the present disclosure will be described in more detail with reference to embodiments, but the present disclosure is not limited to the following embodiments.

### EMBODIMENTS

### Embodiment 1: Ammonia Adsorption and Recovery Using Marine Engine Ammonia Catch System Under Desorption Conditions of 150° C. and Atmospheric Pressure

To capture ammonia by using the marine engine ammonia catch system of the present disclosure, an experiment of recovering ammonia by adsorbing and desorbing ammonia in a vessel pipe by using a method using a simulated gas using the temperature swing ammonia catch system 100 as shown in FIG. 1 was performed.

The experiment of recovering ammonia was performed through steps of adsorption, heating regeneration, cooling, and waiting by using three adsorption towers as shown in FIG. 1. A flow rate of a mixed gas was 22 liter/min, each of first, second, and third adsorption towers was filled with only 100 wt % of zeolite porous adsorbent without mixing silica, alumina, activated carbon, etc. The amount of adsorbent filled in each adsorption tower was 100 g. A mixed gas at atmospheric pressure and room temperature was injected into the first adsorption tower.

A process was performed in which a mixed gas of 50 vol % of ammonia and 50 vol % of nitrogen was injected as a raw material gas to adsorb and remove ammonia, and after adsorption, ammonia was desorbed through heating regeneration at 150° C. and atmospheric pressure and high-purity liquid ammonia was recovered through pressurization.

This continuous process of adsorption, heating regeneration, cooling, and waiting was repeatedly performed 100 times, and high-purity ammonia concentration analysis was performed by using a chemiluminescence analyzer. As a result, it was found that an adsorption time was stably maintained at 30 minutes. Also, it was found that the content of ammonia was removed from the mixed gas including 50 vol % of ammonia and 50 vol % of nitrogen down to about 0.1 ppm, and the recovered ammonia concentration was about 95 vol %, which was significantly concentrated compared to the introduced concentration (50 vol %).

Also, as a result of performing the above continuous process of adsorption, heating regeneration, cooling, and waiting 100 times additionally, it was found that after adsorption, the content of ammonia in the mixed gas was still 0.1 ppm, a decrease in adsorption time did not exceed 5%, and an ammonia concentration was somewhat lowered to a minimum of 94 vol % during desorption, but remained stable and recovered.

### Embodiment 2: Ammonia Adsorption and Recovery Using Marine Engine Ammonia Catch System Under Desorption Conditions of 200° C. and Atmospheric Pressure

An experiment of recovering ammonia was performed under the same conditions as in Embodiment 1, except that the experiment was performed under desorption conditions of 200° C. and atmospheric pressure.

As a result, it was found that the content of ammonia after adsorption was removed from the mixed gas including 50 vol % of ammonia and 50 vol % of nitrogen down to about 0.1 ppm like in Embodiment 1, and an adsorption time was stably maintained at 40 minutes. It was found that the adsorption amount was increased due to high-temperature regeneration compared to Embodiment 1 and the ammonia concentration during desorption was still stably maintained at about 96 vol %.

Also, as a result of performing the continuous process of adsorption, heating regeneration, cooling, and waiting 100 times additionally, it was found that after adsorption, the content of ammonia in the mixed gas was still maintained at about 0.1 ppm, a decrease in adsorption time did not exceed 3%, and an ammonia concentration was somewhat lowered to a minimum of 95 vol %, but remained stable and recovered.

### Embodiment 3: Ammonia Adsorption and Recovery Using Marine Engine Ammonia Catch System Using Nitrogen Purge Gas Under Desorption Conditions of 200° C. and Atmospheric Pressure An experiment of recovering ammonia was performed under the same conditions as in Embodiment 2, except that a nitrogen gas was introduced as an ammonia purge gas to an adsorption tower and cleaned at a flow rate of 1 L/min for the last minute in the desorption step.

As a result, it was found that the content of ammonia was removed from the mixed gas including 50 vol % of ammonia and 50 vol % of nitrogen down to about 0.07 ppm, an adsorption time was increased and maintained stably for about 50 minutes, and ammonia could be recovered at a concentration of about 99.5 vol % in terms of regeneration, and thus, the effects of the residual amount of ammonia in the mixed gas after adsorption, ammonia adsorption maintaining time, and regeneration were all improved compared to Embodiments 1 and 2.

As such, it was found that when nitrogen was used as an ammonia purge gas, the residual amount of ammonia in recovered nitrogen could be reduced and an ammonia recovery concentration could be increased, thereby minimizing contamination due to ammonia emissions.

In addition, it was found that when an adsorption time was increased by using nitrogen as an ammonia purge gas, the use of a small amount of adsorbent and the compact design of the adsorption tower were possible, thereby reducing installation costs.

It was found that after additional 100 adsorptions, the content of ammonia in the mixed gas was 0.08 ppm, a decrease in adsorption time was within 1%, and an ammonia concentration was slightly lowered to 99 vol % during desorption but remained stable.

### Embodiment 4: Ammonia Adsorption and Recovery Using Marine Engine Ammonia Catch System Using Both Nitrogen Purge Gas and Ammonia Purge Gas Under Desorption Conditions of 200° C. and Atmospheric Pressure

An experiment of recovering ammonia was performed under the same conditions as in Embodiment 3, except that part of recovered ammonia (ammonia concentration of 99.3 vol %) was introduced to an adsorption tower and cleaned at a flow rate of 1 L/min for the last minute in the desorption step.

As a result, it was found that the content of ammonia was removed from the mixed gas including 50 vol % of ammonia and 50 vol % of nitrogen down to about 0.05 ppm, an adsorption time was increased and stably maintained for about 70 minutes, and ammonia could be recovered at a concentration of about 99.8 vol % in terms of regeneration, and thus, the effects of the residual amount of ammonia in the mixed gas after adsorption, ammonia adsorption maintaining time, and regeneration were all improved compared to Embodiment 1 and Embodiment 2 as well as Embodiment 3.

It was found that after additional 100 adsorptions, the content of ammonia in the mixed gas was 0.05 ppm without reduction, an adsorption time was maintained at 70 minutes without reduction, and an ammonia concentration was still stably maintained at 99.8 vol % without reduction.

### REFERENCE SIGNS

100: TSA device
101: raw material supply pipe
102-105: a plurality of pipes
106: nitrogen-ammonia recovery pipe
107: compressor
111: first adsorption tower
112: second adsorption tower
113: third adsorption tower
121: ammonia storage tank
131: nitrogen storage tank
141: gas-liquid separation bath
11, 21, 31: raw material injection valve
12, 22, 32: ammonia recovery valves
13, 23, 33: ammonia purge gas injection valves
14, 24, 34: nitrogen gas recovery valves
15, 25, 35: nitrogen gas injection valves

1. A marine engine ammonia catch system comprising a temperature swing adsorption device,
wherein the temperature swing adsorption device comprises:
a plurality of adsorption towers connected to a raw material supply pipe and comprising an ammonia removal unit configured to adsorb and remove ammonia from a mixed gas introduced from the raw material supply pipe;
a nitrogen storage tank connected to the plurality of adsorption towers and storing nitrogen separated after the ammonia is removed from the mixed gas in the plurality of adsorption towers;
a gas-liquid separation bath configured to separate purified ammonia from the plurality of adsorption towers;
a compressor connected to the gas-liquid separation bath and configured to liquefy the ammonia;
an ammonia storage tank storing the liquefied ammonia;
a plurality of pipes connecting the plurality of adsorption towers, the nitrogen storage tank, the gas-liquid separation bath, the compressor, and the ammonia storage tank; and
a plurality of valves configured to respectively open and close the plurality of pipes.

2. The marine engine ammonia catch system according to claim 1, wherein each of the plurality of adsorption towers is filled with a porous adsorbent that selectively adsorbs ammonia in the mixed gas supplied through the raw material supply pipe,
wherein the porous adsorbent comprises 80 to 100 wt % of zerolite and 0 to 20 wt % of at least one selected from among a metal-impregnated activated carbon adsorbent, a silica adsorbent, an alumina adsorbent, and an alumina-silica adsorbent.

3. The marine engine ammonia catch system according to claim 1, wherein the plurality of valves configured to respectively open and close the plurality of pipes comprise:
a nitrogen gas injection valve connected to the plurality of adsorption towers and the nitrogen storage tank and configured to inject a nitrogen gas;
a nitrogen gas recovery valve connected to the plurality of adsorption towers and the nitrogen storage tank and configured to recover a nitrogen gas;
an ammonia purge gas injection valve connected to the plurality of adsorption towers and the gas-liquid separation bath and configured to inject an ammonia purge gas; and
an ammonia recovery valve connected to the plurality of adsorption towers and the compressor and configured to recover ammonia.

4. The marine engine ammonia catch system according to claim 1, further comprising a nitrogen recovery pipe configured to recover part of nitrogen stored in the nitrogen storage tank from the nitrogen storage tank to the plurality of adsorption towers,
wherein the plurality of valves configured to respectively open and close the plurality of pipes additionally comprise a nitrogen gas injection valve connected to the nitrogen storage tank and the plurality of adsorption towers and configured to inject a nitrogen gas.

5. The marine engine ammonia catch system according to claim 4, further comprising an ammonia recovery pipe configured to recover part of ammonia stored in the ammonia storage tank from the ammonia storage tank to the plurality of adsorption towers,
wherein the plurality of valves configured to respectively open and close the plurality of pipes additionally comprise an ammonia gas injection valve connected to the ammonia storage tank and the plurality of adsorption towers and configured to inject ammonia.

6. An ammonia fuel recovery method using the marine engine ammonia catch system according to claim 1 comprising the temperature swing adsorption device, the ammonia fuel recovery method comprising:
a step of selectively adsorbing ammonia by passing a mixed gas supplied from the raw material supply pipe through the plurality of adsorption towers;
a step of storing nitrogen remaining after the ammonia is adsorbed in the nitrogen storage tank;
a step of heating an adsorption tower comprising a porous adsorbent to which the ammonia is adsorbed to desorb the ammonia from the porous adsorbent to which the ammonia is adsorbed;
a step of compressing and liquefying the desorbed ammonia with a compressor;
a step of separating liquid ammonia and residual nitrogen from the liquefied ammonia; and
a step of recovering the liquid ammonia and storing the recovered liquid ammonia in the ammonia storage tank.

7. The ammonia fuel recovery method using the marine engine ammonia catch system according to claim 6, wherein the step of desorbing the ammonia is performed under conditions of atmospheric pressure and 180 to 220° C.

8. The ammonia fuel recovery method using the marine engine ammonia catch system according to claim 7, wherein the step of desorbing the ammonia further comprises a nitrogen gas purge step of supplying part of nitrogen stored in the nitrogen storage tank to the plurality of adsorption towers as a purge gas.

9. The ammonia fuel recovery method using the marine engine ammonia catch system according to claim 7, wherein the nitrogen gas purge step is performed for 1/1000 to 1/100 of a total desorption step time at an end of the desorption step.

10. The ammonia fuel recovery method using the marine engine ammonia catch system according to claim 8, wherein the step of desorbing the ammonia further comprises an ammonia purge step of supplying part of ammonia stored in the ammonia storage tank to the plurality of adsorption towers as a purge gas.

11. The ammonia fuel recovery method using the marine engine ammonia catch system according to claim 9, wherein ammonia supplied in the ammonia purge step has a concentration of 99% or more.

12. The marine engine ammonia catch system according to claim 11, wherein each of the plurality of adsorption towers is filled with a porous adsorbent that selectively adsorbs ammonia in the mixed gas supplied through the raw material supply pipe,
wherein the porous adsorbent comprises 80 to 100 wt % of zerolite and 0 to 20 wt % of at least one selected from among a metal-impregnated activated carbon adsorbent, a silica adsorbent, an alumina adsorbent, and an alumina-silica adsorbent.

13. The ammonia fuel recovery method using the marine engine ammonia catch system according to claim 12, wherein the step of adsorbing the ammonia is performed so that a content of ammonia in the mixed gas at room temperature and atmospheric pressure is less than 1 ppm,
wherein a time for which the adsorbing of the ammonia is maintained exceeds 40 minutes, and
a concentration of the recovered ammonia is 99 vol % or more.

14. The ammonia fuel recovery method using the marine engine ammonia catch system according to claim 13, wherein the step of adsorbing the ammonia is performed so that a content of ammonia in the mixed gas at room temperature and atmospheric pressure is less than 1 ppm,
wherein a time for which the adsorbing of the ammonia is maintained exceeds 40 minutes, and
a concentration of the recovered ammonia is 99 vol % or more.
